(19) United States
(12) Patent Application Publication
(10) Pub. No.: US 2004/0146653 A1
(43) Pub. Date: Jul. 29, 2004

(54) Coating biscuit tiles with an abrasion-and scratch-resistant coat

(76) Inventors: Pepe Diego, Mogliano Veneto (IT); Alberto Silvestro Cagnola, Castel Franco Veneto (IT); Ann Kerstin Birgitta Kjellqvist-Lindell, Malmo (SE)

Correspondence Address: Oliff & Berridge, PO Box 19928, Alexandria, VA, 22320, US

(21) Appl. No.: 10/476,256

(22) PCT Filed: May 24, 2002
(86) PCT No.: PCT/EP02/05746

(30) Foreign Application Priority Data
May 31, 2001 (EP) 01202059.0

(51) Int. Cl. B05D 3/02

(52) U.S. Cl. 427/387; 427/487

(57) ABSTRACT

The invention relates to a process for coating biscuit tiles wherein at least one coating composition is applied to the biscuit tile, characterised in that the composition comprises silica particles, a substantially silicon-free polymerisable compound, and a silane of the general formula R¹—Si(OR)₃, wherein R¹ is a substantially silicon-free polymerisable group and R is a hydrocarbon radical. The process according to the present invention does not require the reheating step which is compulsory when preparing (glazed) ceramic tiles. Nonetheless, an abrasion-, scratch- and fire-resistant coating layer is obtained.

The present invention relates to a process for coating biscuit tiles and the coated tiles thus obtained. In particular, it relates to the coating of decorated and undecorated tiles that can be used as interior tiles.

Interior tiles are often ceramic tiles. In a standard production process biscuit tiles are manufactured by heating unbaked clay base material in an oven to remove moisture from the clay, i.e. biscuit burning. The biscuit tiles are often coated with a glaze composition. Then, the glazed or unglazed biscuit tiles are reheated at high temperatures between 800 and 130⁰° C., i.e. firing. During this firing step numerous physical and chemical changes take place in the clay material, such as dissociation, compound formation, polymorphic transformation, sintering, and vitrification. If present, the glaze material becomes vitrified and inert and fuses with the ceramic surface during the reheating. It is also possible to fire the biscuit tile before the application and curing of the glaze. This process thus requires two reheating steps at relatively high temperatures and generally results in a superior glaze quality. A glazed tile has a glossy, smooth surface, and the glaze protects the tile against water, chemicals, heat, and abrasion.

Interior tiles are frequently decorated. U.S. Pat. No. 5,989,636 is concerned with decorating glazed ceramic tiles by preparing a pigmented or decal glaze with which the glazed tile is overglazed. The curing of the overglaze is performed using exact firing temperatures in order to let the colours mature properly. The demanding curing conditions are a drawback of this method.

In FR 2567 456 a process for decorating glazed ceramic tiles is disclosed in which the top coating material comprises a UV-polymerisable resin. A tile, for instance a bathroom tile, is coated with a primer, an adhesive layer, an image fragment, and a varnish layer. The varnish layer comprises a UV-polymerisable resin and is curable at low temperatures. The varnish is applied to protect the image fragment, but the document does not disclose a scratch- and abrasion-resistant varnish.

The reheating step(s) in the conventional manufacturing processes of ceramic interior tiles involve(s) high energy costs, pollution, and a relatively long processing time. Therefore, manufacturing processes for interior tiles in which biscuit tiles as such are used have been developed. In these processes the disadvantageous reheating step(s) can be left out.

DE 2 240 987 discloses a process for spray coating biscuit tiles with a multi-component epoxy resin. After coating the tiles do not have to be subjected to a heating treatment in order to cure the coat. A drawback of this method is that the resulting coat does not show sufficient abrasion- and scratch-resistance.

In JP 5 9111 988 a tile coating process is disclosed that involves coating a biscuit tile with an electron radiation curable coating material. The coating material comprises a base resin having unsaturated bonds as the skeleton structure and functional groups. The coating further comprises vinyl monomers having a group capable of addition-reacting or condensation-reacting with the functional groups of the base resin. The electron radiation curing coating material is applied to an unglazed tile substrate in which it can partially permeate. Due to the permeation of the coating material in the tile, an anchoring effect is achieved. In order to obtain a sufficient level of permeation, the water absorbing rate of the tile has to be between 1 and 20%, preferably between 3 and 9%. This requirement limits the applicability of the process.

Radiation curable coating compositions are described for instance in U.S. Pat. No. 4,348,462, U.S. Pat. No. 4,455,205, and EP 1 008 631. These coating compositions comprise silica particles, polymerisable acrylic monomers, and a silane. It is disclosed that these coating compositions can be used to protect for instance polycarbonate substrates, wood, painted surfaces, leather, glass, ceramics, and textiles. None of the documents disclose the use of the silica comprising radiation curable coating compositions on bisqued clay substrates. Additionally, it is not disclosed or suggested that these coating compositions could be advantageous in the production of coated biscuit tiles.

U.S. Pat. No. 6,136,383 discloses a process for coating mineral mouldings, for instance bisqued clay articles, with a radiation curable silicon-containing coating composition. The coating composition comprises one or more polymers having ethylenically unsaturated double bonds, for instance ethylenically unsaturated siloxanes. A disadvantage of this silicon-containing coating composition is that the resulting coat shows poor scratch resistance.

EP 0 801 099 discloses a process for the preparation of a coating composition for heavy duty applications. A polymer having optionally masked hydroxy groups is reacted with a curing agent having substituents that are reactive towards said optionally masked hydroxy groups in the presence of an organosol. The organosol consists of particles of silicon dioxide grafted with organic compounds such as 1,6-hexanediol diacrylate. The obtained coating composition is suitable for coating ships, off-shore structures, floors and walls, e.g. concrete floors and walls. The document does not disclose or suggest that the coating composition could be advantageous in the production of coated biscuit tiles.

The present invention provides a solution to the above-mentioned problems and disadvantages involved in standard biscuit tile coating procedures. The process according to the present invention for coating biscuit tiles, wherein at least one coating composition is applied to the biscuit tile, is characterised in that the coating composition comprises silica particles, a substantially silicon-free polymerisable compound, and a silane of the general formula:

R¹—Si(OR)₃

wherein

R¹ is a substantially silicon-free polymerisable group

R is a hydrocarbon radical.

The process according to the present invention does not require a reheating step at relatively high temperature, i.e. firing, which is compulsory when preparing (glazed) ceramic tiles. This has various advantages: lower energy costs, less pollution, and a reduced processing time. Another advantage concerns colour control. In conventional processes colour control is problematical during the reheating step. The process according to the invention offers improved colour control, since the tiles do not have to be reheated. Because of the constant colour quality the range of possible colours is increased.

The present invention further relates to the coated biscuit tiles thus obtained, which may be decorated or not. The quality of the coat is improved over the known radiation curable coats applied to biscuit tiles. The coated tiles obtained according to the process of the invention show enhanced abrasion and scratch resistance. A regular radiation cured coat will start to burn almost immediately when exposed to heat or fire. A surprising advantage of biscuit tiles coated according to the process of the present invention is their heat and fire resistance, particularly when heated or fired perpendicular to the coated surface.

In principle, there is no restriction with regard to the coating compositions that can be used in a coating process according to the present invention, as long as curing at high temperatures, i.e. above 200° C., is not necessary. Examples of suitable curing mechanisms include oxidative drying systems and polyurethane systems, for instance carbonate/amine systems and isocyanate cured systems, such as hydroxyl/isocyanate, amine/isocyanate, thiol/isocyanate, malonate/isocyanate, ketimine/isocyanate and aldimine/isocyanate. The coating composition may be curable by Michael reaction. Examples of these are melamine cured systems, acryloyl/amine, acryloyl/acetoacetate, acryloyl/malonate, acryloyl/thiol, and acryloyl/ketimine systems. Other activated double bond containing monomers instead of acryloyl can be used as well. Further examples of suitable curing mechanisms are epoxy/amine, epoxy/hydroxy and epoxy/thiol systems, and epoxy/acid systems, which can be used in powder coatings. Also amine/malonate, amine/acetoacetate anhydride/amine, anhydride/hydroxyl systems and variants using blocked hydroxyls or amines may be used. Examples of radiation curable systems are cationically curing epoxy systems, vinylether systems, and radically cured systems such as (meth)acryloyl based, maleate/vinylether or thiol/ene systems.

A primary concern in the coating industry is the need to reduce the amount of solvent released during the drying and curing of coating compositions. Therefore, preference is given to the use of a high solids solvent borne coating composition, a waterborne coating composition, a UV- or EB-curable coating composition, optionally comprising a reactive diluent, or a hot melt coating composition. Since the manufacture of coated tiles according to the present invention on an industrial scale preferably takes place within a relatively short time, the curing and drying time of the coating composition should be as short as possible. Heating the substrate can accelerate the curing and drying of the coating composition. Preferably, radiation curable coating compositions that can be cured in a reasonably short time are used. Within the framework of the present invention, a radiation curable coating composition is a coating composition that is cured using electromagnetic radiation having a wavelength λ≦500 nm or electron beam radiation. An example of electromagnetic radiation having a wavelength λ≦500 nm is, e.g., UV radiation.

In a process according to the invention, the coating composition comprises silica particles, a substantially silicon-free polymerisable compound, and a silane of the general formula: R¹—Si(OR)₃, wherein R¹ is a substantially silicon-free polymerisable group and R is a hydrocarbon radical. In a preferred embodiment of the invention, the silica particles are nano-particles. Optionally, the coating composition comprises a diluent, for instance to obtain a suitable application viscosity. The coating composition can be applied to the substrate by conventional means, such as by curtain coater, spray nozzle, roller coater, or by flow coater.

The silane is capable of polymerising with the substantially silicon-free polymerisable compound in the coating composition. In other words, the substantially silicon-free polymerisable group R¹ is reactive towards the polymerisable compound. The group R of the silane preferably is a methyl or ethyl radical. R¹ may have a group that is capable of taking part in a radical polymerisation reaction or it may have a isocyanate-reactive functional group, or it may be cured via another mechanism, e.g. (pseudo)-Michael addition. Preferably, R¹ is a radiation curable group. Thus silanes with an R¹ group having at least one olefinically unsaturated bond are suitable in radiation curable coating compositions.

Unlimitative examples of suitable R¹ groups are carbonyl-functional groups, amine-functional groups, amide-functional groups, oxidatively drying groups such as fatty acid groups, malonate groups, acetoacetate groups, hydroxy-functional groups, isocyanate-functional groups, mercapto-functional groups, vinylether groups, carbonate-functional groups, anhydride-functional groups, and epoxy-functional groups. Blocked versions of the aforementioned groups may be used as well. Preferably, R¹ consists of an acryloxy-functional group, a vinyl-functional group, or a glycidoxy-functional group. Vinylsilanes that were found to be very suitable in radiation curable coating compositions according to the present invention are of the general formula: H₂C═CH—Si(OR)₃, wherein R is a methyl or ethyl radical.

The polymerisable compound in the coating composition should be substantially silicon-free. As stated above, acrylic-functional polysiloxanes, such as described in U.S. Pat. No. 6,136,383, are not suitable. When for instance Crodamer UVS-500 (an acrylic-functional polysiloxane obtainable from Croda) is used, the coat shows poor scratch resistance. In principle, any substantially silicon-free polymerisable compound or mixture of polymerisable compounds can be used in the coating compositions used in the process according to the present invention. This polymerisable compound is present in an amount of 5 to 80 wt. %, based on the total weight of the coating composition. Preferably, the polymerisable compound is present in an amount of 15 to 70 wt. %, more preferred is an amount of 30 to 60 wt. %, based on the total weight of the coating composition.

The polymerisable compound can be a monomer, polymer, or oligomer. In principle, there is no restriction with regard to the curing reactions in which the polymerisable compound can take part. Suitable polymerisable compounds are, optionally in the presence of a cross-linker, reactive towards themselves. Appropriate polymerisable compounds have at least one functional group which, optionally in the presence of a cross-linker, is capable of reacting with the R¹ group of the silane in the coating composition. Unlimitative examples of suitable polymerisable compounds are compounds having two or more functional groups like isocyanate groups, hydroxy groups, amine groups, oxidatively drying groups such as fatty acid groups, carbonyl groups, vinylether groups, epoxy groups, malonate groups, acetoacetate groups, carbonate groups, and anhydride groups. Blocked versions of the aforementioned groups may be used as well. Other examples of suitable polymerisable compounds are compounds having one or more acrylate groups, blocked or not. Thus suitable polymerisable compounds are for instance polyesters, polyacrylates, polyisocyanates, polyurethanes, alkyd resins, polyepoxy compounds, polyethers and polyamines.

Examples of at least difunctional isocyanate compounds include aliphatic, cycloaliphatic or aromatic di-, tri- or tetraisocyanates which may be ethylenically unsaturated or not, such as:

1,2-propylene diisocyanate, trimethylene diisocyanate, tetramethylene diisocyanate, 2,3-butylene diisocyanate, hexamethylene diisocyanate, octamethylene diisocyanate, 2,2,4trimethyl hexamethylene diisocyanate, 2,4,4-trimethyl hexamethylene diisocyanate, dodecamethylene diisocyanate; ω,ω′-dipropyl ether diisocyanate, 1,3-cyclopentane diisocyanate, 1,2-cyclohexane diisocyanate, 1,4-cyclohexane diisocyanate, isophorone di-isocyanate, 4-methyl-1,3-diisocyanatocyclohexane, trans-vinylidene diisocyanate, dicyclohexyl methane-4,4′-diisocyanate, 3,3′-dimethyl dicyclohexyl methane-4,4′-diisocyanate, a toluene diisocyanate, 1,3-bis(isocyanatomethyl)benzene, a xylene diisocyanate, 1,5-dimethyl-2,4-bis(isocyanatomethyl)benzene, 1,5-dimethyl-2,4-bis(2-isocyanatoethyl)-benzene, 1,3,5-triethyl-2,4-bis(isocyanatomethyl)-benzene, 4,4′-diisocyanatodiphenyl, 3,3′-dichloro-4,4′-diisocyanatodiphenyl, 3,3′-diphenyl-4,4′-diisocyanatodiphenyl, 3,3′-dimethoxy-4,4′-diisocyanatodiphenyl, 4,4′-diisocyanatodiphenyl methane, 3,3′-dimethyl4,4′-diisocyanatodiphenyl methane, a diisocyanatonaphthalene, the adduct of 2 molecules of a diisocyanate, e.g. hexamethylene diisocyanate or isophorone diisocyanate, to a diol such as ethylene glycol, the adduct of 3 molecules of hexamethylene diisocyanate to 1 molecule of water (available under the trade designation Desmodur®N of Bayer®), the adduct of 1 molecule of trimethylol propane to 3 molecules of toluene diisocyanate (available under the trade designation Desmodur®L of Bayer®), the adduct of 1 molecule of trimethylol propane to 3 molecules of isophorone diisocyanate, compounds such as 1,3,5-triisocyanatobenzene and 2,4,6-triisocyanatotoluene, and the adduct of 1 molecule of pentaerythritol to 4 molecules of toluene diisocyanate. Preferably, an aliphatic or cycloaliphatic di- or triisocyanate having 8-36 carbon atoms is employed.

Typical examples of compounds containing at least 2 acryloyl or methacryloyl groups include the (meth)acrylic esters of di-, tri- or polyvalent polyols, including polyester polyols and polyether polyols; adducts of, on the one hand, a hydroxyl group-containing (meth)acrylic ester of a polyol to, on the other hand, an at least difunctional isocyanate compound; and adducts of (meth)acrylic acid to an at least difunctional epoxy compound.

Examples of suitable at least difunctional, solid or liquid epoxy compounds include the di- or polyglycidyl ethers of (cyclo)aliphatic or aromatic hydroxy compounds such as ethylene glycol, glycerol, cyclohexane diol, mononuclear di- or polyvalent phenols, bisphenols such as Bisphenol-A and Bisphenol-F, and polynuclear phenols; glycidyl ethers of fatty acids having, say, 6-24 carbon atoms; glycidyl(meth)acrylate; isocyanurate group-containing epoxy compounds, an epoxydised polybutadiene; hydantoin epoxy resins; epoxy resins obtained by epoxydising aliphatic and/or cycloaliphatic alkenes, such as dipentene dioxide, dicyclopentadiene dioxide, and vinylcyclohexene dioxide, and glycidyl groups-containing resins such as polyesters or polyurethanes containing one or more glycidyl groups per molecule, or mixtures of the aforesaid epoxy resins.

Preferably, a radiation curable resin or mixture of resins is used as polymerisable compound. Urethane acrylates were found to be very suitable for use in the coating composition. Examples of suitable commercially available urethane acrylate resins are: Ebecryl 210, Ebecryl 2000, Ebecryl 5129, Ebecryl 8800 (all ex UCB), CN 934, CN 976, CN 981 (all ex Cray Valley), Genomer 4258, Genomer 4652, and Genomer 4675 (all ex Rahn). A mixture of a urethane acrylate with a polyethylene wax or a polypropylene wax was also found to be suitable.

A cationic UV-curable system can also be used in the coating composition. Such a system can be based on, for example, cycloaliphatic epoxides or cycloaliphatic epoxyacrylates. Examples of commercially available cationic UV-curable materials are: Uvacure 1500, Uvacure 1501, Uvacure 1502, Uvacure 1530, Uvacure 1531, Uvacure 1532, Uvacure 1533 (all ex UCB), Cyracure UVR 6105, Cyracure UVR 6110, and Cyracure UVR 6128 (all ex Union Carbide). As curing initiators for these systems can be used, for instance, UVI 6976, UVI 6992, and UVI 8892 (all ex Union Carbide). Polyesteracrylate resins can also be used in the coating composition according to the present invention. Examples of suitable commercially available polyesteracrylate resins are: Crodamer UVP-215, Crodamer UVP-220 (both ex Croda), Genomer 3302, Genomer 3316 (both ex Rahn), Laromer PE 44F (ex BASF), Ebecryl 800, Ebecryl 810 (both ex UCB), Viaktin 5979, Viaktin VTE 5969, and Viaktin 6164 (100%) (all ex Vianova).

Epoxyacrylate resins can also be used in the coating composition. Examples of commercially available epoxyacrylate resins are: Crodamer UVE-107 (100%), Crodamer UVE-130 (both ex Croda) Genomer 2254, Genomer 2258, Genomer 2260, Genomer 2263 (all ex Rahn), CN 104 (ex Cray Valley), and Ebecryl 3500 (ex UCB). Polyetheracrylate resins can also be used in the coating composition. Examples of commercially available polyetheracrylate resins are: Genomer 3456 (ex Rahn), Laromer P033F (ex BASF), Viaktin 5968, Viaktin 5978, and Viaktin VTE 6154 (all ex Vianova).

The amount of silane and the amount of silica particles mainly determine the silica content of the coating composition. The silica content is expressed as a percentage by weight of the total weight of the coating composition, and is determined through oven pyrolysis at 800° C. The total silica content is preferably up to 30% by weight, and more preferably 5-25% by weight. Optimum results are obtained in the range of 17-23% total silica by weight. The silica particles preferably have an average diameter of between 5 and 100 nm, more preferably between 15 and 75 nm, and even more preferably between 20 and 50 nm. Optimum results were been obtained with silica particles having an average diameter of approximately 25 nm.

As stated above, the coating composition preferably comprises a vinylsilane of the general formula: H₂C═CH—Si(OR)₃ wherein R is a methyl or ethyl radical. If such a vinylsilane is used, the preferred quantity of vinylsilane is between 0.2 gram and 1.25 grams per gram of initial dry silica. More preferably, the quantity of vinylsilane is between 0.3 gram and 0.65 gram.

Examples of suitable commercially available compositions that can be used for the preparation of a coating composition according to the present invention are Highlink OG 1, Highlink OG 2, Highlink OG 4, Highlink OG 5, Highlink OG 8, Highlink OG 100, Highlink OG 101, Highlink 103, Highlink OG 108, Highlink OG 113, Highlink OG 120, Highlink OG 130, Highlink OG PO 33F, Highlink OG VTE 5968, Highlink OG 200, Highlink OG 202, Highlink OG 401, Highlink OG 502, and Highlink OG 601 (all ex Clariant). These compositions contain a vinylsilane, silica particles, and a diluent.

Optionally, the coating composition according to the invention comprises a diluent. If a diluent is used, it can be either reactive or non-reactive towards the other components in the coating composition. Preferably, the coating composition of the present invention comprises one or more reactive diluents. Such a reactive diluent, optionally in the presence of a cross-linker, is at least reactive towards the polymerisable compound. The reactive diluent, optionally in the presence of a cross-linker, may also be reactive towards the R¹ group of the silane in the coating composition. Preferably, the diluent is substantially silicon free. Unlimitative examples of suitable diluents are compounds having one or more amine groups, oxidatively drying groups, vinylether groups, malonate groups, acetoacetate groups, mercapto groups, epoxy groups, carbonyl groups, isocyanate groups, hydroxy groups, carbonate groups, or anhydride groups.

In general, oligomeric versions of polymerisable compounds are suitable as diluents in curable systems according to the invention. Examples of suitable diluents for urethane systems are low-viscosity diols and diamines, optionally blocked. For epoxy systems (cyclo)aliphatic mono- and bi-epoxies may be used as diluents. In the case of a radiation curable coating composition, compounds suitable as reactive diluents generally are ethylenically unsaturated compounds. As representative examples of such may be mentioned the compounds disclosed in EP-A-0 965 621. The reactive diluent preferably has a molecular weight of from about 80 to about 800, more preferably about 100 to about 400. Compounds meeting the molecular weight requirement are suitable for lowering the viscosity of the coating composition. Preferably, reactive diluents are used in an amount of 0 to 50 wt. % on solid resin, more preferably 10 to 40 wt. %.

Examples of monofunctional reactive diluents include the esters of acrylic and methacrylic acid, such as methyl (meth)acrylate, ethyl (meth)acrylate, propyl (meth)acrylate, isopropyl (meth)acrylate, butyl (meth)acrylate, isobutyl (meth)acrylate, tertiary butyl (meth)acrylate, neopentyl (meth)acrylate, isopentyl (meth)acrylate, n-hexyl (meth)acrylate, isohexyl (meth)acrylate, n-heptyl (meth)acrylate, iso-heptyl (meth)-acrylate, octyl (meth)acrylate, iso-octyl (meth)acrylate, 2-ethylhexyl (meth)acrylate, nonyl (meth)acrylate, iso-nonyl (meth)acrylate, decyl (meth)acrylate, iso-decyl (meth)-acrylate, undecyl (meth)acrylate, iso-undecyl (meth)acrylate, dodecyl (meth)acrylate, iso-dodecyl (meth)acrylate, tridecyl (meth)acrylate, iso-tridecyl (meth)acrylate, tetradecyl (meth)acrylate, iso-tetradecyl (meth)acrylate, and mixtures thereof. Moreover, the aforesaid esters of acrylic and methacrylic acid may contain radiation-reactive unsaturation in the alcohol radical as well. Additional monofunctional radiation-sensitive compounds which may be used as a reactive diluent include diallyl maleate, diallyl fumarate, vinyl acetate, and N-vinyl-2-pyrrolidone, especially the last compound.

The preferred reactive diluents in the coatings of the present invention are those having more than one radiation sensitive bond. Such compounds ordinarily are the esters of acrylic or methacrylic acid and a polyhydric alcohol. Further suitable reactive diluents are urethane acrylates, melamine acrylates, epoxy-acrylic acid adducts, and reactive diluents containing polyethylene oxide. Examples of the aforesaid difunctional diluents are ethylene glycol diacrylate and dimethacrylate; isopropylene and propylene glycol diacrylate and dimethacrylate. Similarly, the diol diacrylates and dimethacrylates of butane, pentane, hexane, heptane, and so forth up to and including thirty-six carbon diols are useful in the present coats as reactive diluents.

Tripropylene glycol diacrylate, trimethylolpropane ethoxytriacrylate, 1,6-hexanediol diacrylate, monofunctional vinylacrylate, and mixtures thereof were found to be very suitable for radiation curable coating compositions according to the present invention. Coating compositions comprising 1,6-hexanediol diacrylate are most preferred, as they result in coats with optimal chemical and detergent resistance.

Optionally, curing agents such as acid or base catalysts, metal compounds, radical initiators, or photoinitiators are added to the coating composition. Photoinitiators or a mixture of photoinitiators will be suitable in radiation curable compositions. In general, when electron beam radiation is used to cure the composition, it is not necessary to add a photoinitiator. When UV radiation is used, in general a photoinitiator is added. Preferably non-yellowing photoinitiators are used.

Examples of suitable photoinitiators that can be used in radiation curable coating compositions according to the present invention are benzoin ether (Esacure® ex Fratelli Lamberti), benzyl dimethyl ketone acetal (Irgacure® 651 ex Ciba), 1-hydroxy cyclohexyl phenyl ketone (Irgacure® 184 ex Ciba), 2-hydroxy-2-methyl-1-phenyl propane-1-one (Darocur® 1173 ex Ciba), 1-(4-isopropyl phenyl)-2-hydroxy-2-methyl propane-1-one (Darocur® 1116 ex Ciba), diethoxyacetophenone (DEAP® ex Upjohn), methyl thioxanthone (Quantacur® ex Shell), 2,4,6-trimethylbenzoyl diphenyl phosphine oxide (Lucirin TPO® ex BASF), and the bisphosphine oxides such as CGI® 819 and CGI® 403 ex Ciba. It is also possible to use copolymerisable bimolecular photoinitiators or maleimide-functional compounds. Co-initiators such as amine based co-initiators may also be present in the radiation curable coating composition. Also, daylight cure photoinitiators can be used.

Although the total amount of photoinitiator in the composition is not critical, it should be sufficient to achieve acceptable curing of the coating composition when it is irradiated. However, the amount should not be so large that it affects the properties of the cured coating in a negative way. In general, the composition should comprise between 0.1 and 10 wt. % of photoinitiator, calculated on the total weight of the composition when electromagnetic radiation having a wavelength λ≦500 nm is used to cure the coat.

The coating composition may also contain one or more fillers or additives. The fillers may be any fillers known to those skilled in the art, e.g., barium sulphate, calcium sulphate, calcium carbonate, silicas or silicates (such as talc, feldspar, and china clay). Additives such as stabilisers, antioxidants, levelling agents, anti-settling agents, matting agents, rheology modifiers, surface-active agents, amine synergists, halogen-free fire retardants, waxes, or adhesion promoters may also be added. In general, the coating composition according to the present invention comprises 0 to 50 wt. % of fillers and/or additives, calculated on the total weight of the coating composition.

The coating composition used in the process according to the present invention may also contain one or more pigments. Any pigments known to those skilled in the art may be used in the coating composition according to the present invention. In the case of a UV curable coating composition, care should be taken that the pigment does not show a too high absorption of the radiation used to cure the composition. In general, the coating composition according to the present invention comprises 0 to 40 wt. % of pigment, calculated on the total weight of the coating composition.

In one embodiment, the process of the present invention is used to apply the coating composition as a top coat. In general, the covered or uncovered tiles will be coated with a primer coating and/or a sealer coating prior to being coated with the top coating. The purpose of the primer is to improve adhesion. Sealer layers are applied to obtain a smooth coating film on the tile before the top coat of the present invention is applied. Optionally, one or more other coating layers, so-called intermediate coating layers, are applied on top of the smooth coating film on the tile before the top coat is applied. This is done, for example, to get a better adhesion of the top coat or to obtain a top coat with special properties.

In principle, there is no restriction as to the coating compositions that can be used for the coating layer(s), as long as there is good adhesion between the coating layer(s) and the coating film on top of the substrate. Both pigmented and pigment-free coating compositions can be used. In principle, the same types of coating compositions can be used for the optional primer, sealer, and intermediate coating layer(s) as for the top coat layer, although the composition of these coating layer(s) and of the top coating composition need not be the same.

The primer, sealer, and intermediate coating layer(s) can be applied to the covered or uncovered tile by conventional means, such as by curtain coater, spray nozzle, roller coater, or flow coater.

To obtain a suitable application viscosity of the primer, sealer, and intermediate coating layer(s), well-known diluents can be used. In the case of UV-curable compositions, UV-curable monomers can be added as viscosity reducing agents and reactive oligomers.

Examples of these reactive oligomers are tripropylene glycol diacrylate, trimethylol-propane ethoxytriacrylate, 1,6-hexanediol diacrylate, 2-hydroxyethyl methacrylate, monofunctional vinylacrylate, and mixtures thereof.

The coating compositions may further comprise other ingredients, additives or auxiliaries, such as other polymers or polymer dispersions, pigments, dyes, emulsifiers (surfactants), pigment dispersion aids, levelling agents, anti-cratering agents, anti-foaming agents, anti-sagging agents, halogen-free fire retardants, heat stabilisers, UV-absorbers, antioxidants, and fillers.

Optionally, a printing process may be added to the coating process. A print can be applied to the substrate before the top coat is applied. This can be done to obtain a substrate with a special surface structure, colouring, or texture. Thus the tile may be printed prior to the application of the second sealer layer. Optionally, an intermediate coating layer may be pigmented. In the case of a radiation curable pigmented intermediate coat, EB-curing would be preferred to UV-curing.

For the coating of biscuit tiles in an industrial process, preference is given to a process where all coating and curing steps are performed on a single production line. In such a process the tile is placed on a belt which moves at a continuous speed. The tile is then optionally coated with primer, sealer, and/or intermediate coating layer(s), heated or treated in another way to cure the optionally present layer(s), optionally printed, coated with the top coating composition of the present invention, and heated or treated in another way to cure the top coat.

It further is feasible to apply the coating composition according to the present invention to tiles that are covered with a pattern. This pattern may for instance comprise or consist of paper print, silk screen, or plastic, e.g. polyvinyl chloride, polyethylene, or polypropylene. In WO 00/03851 a process for covering the face of a tile or brick support is disclosed. In this process, a layer of glue is spread over at least a portion of the face of a tile, followed by applying a covering. The covering may consist of a synthetic resin film, e.g. polyvinyl chloride, or a paper sheet. After adhesion of the covering, the covering is optionally plastered, painted, dried, and finally finished. Finishing can take the form of glass-papering and/or brushing and/or polishing.

If biscuit tiles covered with polyvinyl chloride are coated according to the process of the present invention, the coating will need some flexibility to be able to accommodate the flexibility of the polyvinyl chloride sheet. Preferably, the flexibility of the applied coating layers is reduced towards the top, and finally the abrasion resistant top coat is applied.

The biscuit tiles coated according to the process of the present invention may be used as for instance wall tiles, e.g. in a kitchen or a bathroom, or as floor tiles. Coated tiles that were covered with polyvinyl chloride prior to the coating process of the present invention are less suitable for use as floor tiles due to the flexibility of the polyvinyl chloride, because heavy items will probably leave pressure marks on those tiles.

Biscuit tiles coated according to the process of the present invention show heat and fire resistance, particularly when heated or fired perpendicular to the coated surface. Additionally, biscuit tiles coated according to the process of the present invention show chemical resistance to substances such as acids, bases, and household detergents. The coating has a pencil hardness of 9H, which refers to the highest level on the scale. When the amount of silica is decreased, the hardness decreases. A composition without silica results in a coat with a pencil hardness of 3-4H. The tiles show good steam resistance, and good heat resistance in dry and in wet condition. The scratch and abrasion resistance of biscuit tiles coated according to the process of the present invention was tested using a so-called PEI test. The PEI test was performed in accordance with EN ISO 10545.7 using iron balls. The coat according to the invention showed a PEI-value of 3-4, which represents a good scratch and abrasion resistance.

### EXAMPLES

The invention will be elucidated with reference to the following examples. These examples are intended to illustrate the invention but are not to be construed as limiting in any manner the scope thereof.

A primer coating composition was prepared from 90 wt. % cycloaliphatic epoxyacrylate resins and 10 wt. % of a divinylether resin.

A first sealer composition was prepared from 30 wt. % monofunctional vinyl acrylate resin, 15 wt. % adhesion improving additive, 6 wt. % photoinitiator, and 48 wt. % of an epoxy acrylate resin.

A second sealer composition was prepared from 47 wt. % polyester acrylate resin, 11 wt. % talcum powder, 0.2 wt. % anti-settling agent, 2.5 wt. % photoinitiator, 10 wt. % tripropyl glycol diacrylate resin, and 29 wt. % epoxy acrylate resin.

An intermediate coating composition was prepared from 34 wt. % polyester acrylate resin, 2 wt. % anti-settling agent, 15 wt. % talcum powder, 4 wt. % photoinitiator, 31 wt. % tripropyl glycol diacrylate resin, 14 wt. % epoxyacrylate resin, 0.1 wt. % levelling agent, and 0.05 wt. % anti-foaming agent.

A top coating composition was prepared from 45 wt. % urethane acrylate resin, 45 wt. % Highlink (ex Clariant), 1 wt. % polypropylene wax, 5 wt. % photoinitiator, 0.025 wt. % bluish pigment, and 4 wt. % 1,6-hexanediol diacrylate diluent.

### Example 1

Sample 1 consisted of a biscuit tile that was covered with polyvinyl chloride. A coating process according to the present invention was applied to this sample using the compositions listed above.

The UV-curable primer coat was applied to the tile by roller coater at 20-25 g/m². The primer coat was cured to the extent that it was still tacky after this curing step.

Then, by roller coating, the first sealer was applied at 20-25 g/m². The sealer was half cured by UV-irradiation.

The second sealer was applied by reverse roller coating at 50-60 g/m². After a full UV-cure the surface was sanded.

Next, two intermediate coating layers were applied by curtain coater at 160 and 180 g/m², respectively. The first intermediate coating layer was half cured before the second intermediate coating layer was applied. After a full UV-cure the tile was sanded. Finally, the top coat was applied by curtain coater at 100 g/m², and the top coat was fully cured by UV-irradiation.

Sample 1 was tested in accordance with Italian standard UNI 9427/89. The sample showed good UV-resistance. Sample 1 also showed good chemical resistance.

The resistance to household cleaning agents was tested in accordance with Italian standard PTP 53/95. The coating proved to be resistant to well-known cleaning agents like Ajax, ammonia (10% solution in water), alcohol, Viakal, Spic & Span, Cif, and Pronto.

The resistance to frequently used liquids was tested in accordance with European standard EN 12720/97. The coat proved to be resistant to liquids such as acetic acid, acetone, ammonia, red wine, citric acid, detergents, coffee, ethanol, ethyl-butyl acetic acid, olive oil, sodium carbonate, sodium chlorate, tea, water, and beer.

Sample 1 was tested in accordance with European standards EN 12721/97 and EN 12722/97. The sample showed good heat resistance in wet and in dry condition. The sample was tested at temperatures between 55° C. and 100° C.

Sample 1 showed good steam resistance. The resistance to steam at 60° C. was tested in accordance with Italian standard PTP 19/95 for 15 minutes up to 240 minutes.

The scratch resistance of sample 1 was tested in a PEI test in accordance with EN ISO 10545.7. The sample showed a value of 3-4, which implies that the sample shows a good scratch and abrasion resistance.

1. A process for coating biscuit tiles wherein at least one coating composition is applied to the biscuit tile, characterised in that the composition comprises silica particles, a substantially silicon-free polymerisable compound, and a silane of the general formula (I):
R¹—Si(OR)₃
wherein
R¹ is a substantially silicon-free polymerisable group
R is a hydrocarbon radical.

2. A process according to claim 1, characterised in that R¹ is a carbonyl-functional, amine-functional, amide-functional, hydroxy-functional, isocyanate-functional, mercapto-functional, vinylether-functional, carbonate-functional group, anhydride-functional, epoxy-functional, acryloxy-functional, vinyl-functional, or a glycidoxy-functional group, a malonate group, an acetoacetate group or an oxidatively drying group.

3. A process according to claim 1 or 2, characterised in that R¹ is an acryloxy-functional, vinyl-functional or glycidoxy-functional group.

4. A process according to any one of claims 1 to 3, characterised in that R is a methyl or ethyl radical.

5. A process according to any one of claims 1 to 4, characterised in that the coating composition is radiation curable.

6. A process according to any one of claims 1 to 5, characterised in that the coating composition has a silica content of 1 to 30% by weight.

7. A process according to any one of claims 1 to 6, characterised in that the silica particles have an average diameter of between 5 and 100 nm.

8. A process according to any one of claims 1 to 7, characterised in that the coating composition comprises a diluent.

9. A process according to claim 8, characterised in that the diluent is 1,6-hexanediol diacrylate or tripropylene glycol diacrylate.

10. A process according to any one of claims 1 to 9, characterised in that the coating composition is applied as a top coat.

11. A process according to any one of claims 1 to 10, characterised in that the biscuit tile is covered with a pattern prior to the application of the coating composition.

12. A process according to claim 11, characterised in that the pattern comprises plastic, silk screen or paper.

13. Coated biscuit tile with enhanced abrasion resistance, characterised in that it is obtained by a process as claimed in one or more of preceding claims 1 to 12.
